(19) United States
(12) Patent Application Publication
(10) Pub. No.: US 2005/0231469 A1
(43) Pub. Date: Oct. 20, 2005

(54) Force reflecting interface system for games

(76) Inventor: Mike Wittig, Santa Clara, CA (US)

Correspondence Address: MICHAEL WITTIG, 111 SARATOGA AVE. #2326, SANTA CLARA, CA, 95051, US

(21) Appl. No.: 11/107,577

(22) Filed: Apr. 14, 2005

Related U.S. Application Data
(60) Provisional application No. 60/562,347, filed on Apr. 14, 2004.

(51) Int. Cl. G09G 5/00

(52) U.S. Cl. 345/156

(57) ABSTRACT

According to one aspect of the invention a networked game system is provided comprising at least two force reflecting interfaces connected to a network, at least of users using the force reflecting interfaces, and at least two of instances of a video game running on computers attached to each of the force reflecting interfaces. Each user's character in the game wields a sword-like device in the video game's virtual world, and each user wields a physical representation of that device in the form of an appropriately sized, shaped, and equipped handle that they grasp in the real world. When the sword-like devices of two characters in the game collide, the force reflecting interfaces exert forces on the two users controlling the characters, making the the users feel as if they were actually in the virtual world fighting each other.

### CROSS-REFERENCES

Priority is claimed from provisional patent application No. 60/562,347 filed on Apr. 14, 2004, the entire disclosure of which is hereby incorporated by reference herein.

### BACKGROUND OF THE INVENTION

1). Field of the Invention

This invention relates to force reflecting interfaces of the type used with computers, more particularly those used with video games.

2). Discussion of Related Art

Video games typically display a virtual world to a user, but the user cannot interact with that world in a highly physical way. For example, two users playing a video game involving swordfighting typically use a mouse or game pad or joystick to play each other. Such interfaces are far from physically feeling like the virtual object the user's character is using in a game. Additionally, the users do not experience in real life the intense collisions between their weapons in the virtual world.

### SUMMARY OF THE INVENTION

According to one aspect of the invention a networked game system is provided comprising at least two force reflecting interfaces connected to a network, at least of users using the force reflecting interfaces, and at least two of instances of a video game running on computers attached to each of the force reflecting interfaces. Each user's character in the game wields a sword-like device in the video game's virtual world, and each user wields a physical representation of that device in the form of an appropriately sized, shaped, and equipped handle that they grasp in the real world. When the sword-like devices of two characters in the game collide, the force reflecting interfaces exert forces on the two users controlling the characters, making the the users feel as if they were actually in the virtual world fighting each other.

### BRIEF DESCRIPTION OF THE DRAWINGS

The invention is further described by way of example with reference to the accompanying drawings wherein:

FIG. 134 is a perspective view of a removable handle which can be attached to a force reflection interface.

FIG. 148 is a front view two users using two force reflection systems in a game over a network;

FIG. 149 shows a flowchart of a method of keeping score in a game using a force reflection interface;

FIG. 151 is a flowchart of a method to detect collisions in a game using a force reflection interface;

FIG. 153 is a block diagram of how information about a user's interface is transmitted over a network;

FIG. 155 shows two block diagrams showing how quaternions are used to interpolate handle positions

FIG. 156 shows a sword-like device in a virtual representation of the game

FIG. 157 shows 6 flowcharts of various methods that can be used to improve the performance of a force reflection interface.

FIG. 159 shows a flowchart for applying a force to an object by using a spring relation.

### DETAILED DESCRIPTION OF THE INVENTION

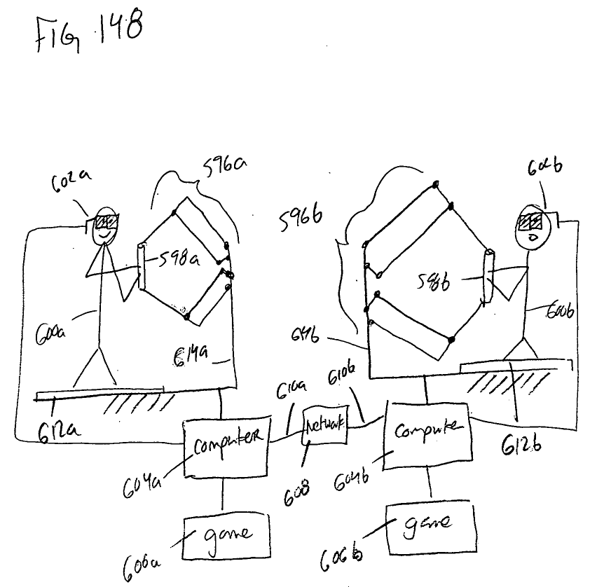

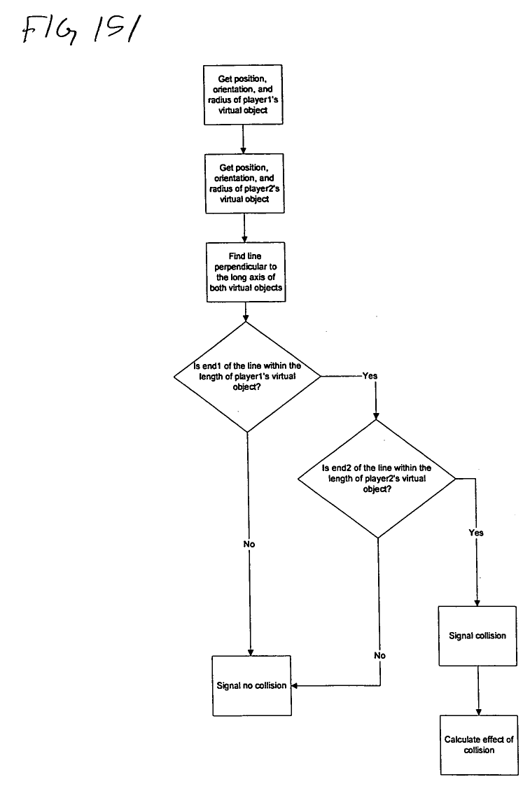

FIG. 148 of the accompanying drawings illustrates the preferred embodiment of the invention. A force reflection interface 596a of the type described in U.S. Pat. No. 6,646,402 is attached to grounded (fixed) surface 614a. Notably, a force reflection interface of the type described in U.S. Pat. No. 6,646,402 allows handle 598a to be controlled not just in terms of its position, but also in terms of its orientation. User 600a holds handle 598a, which is attached to the output of force reflection interface 596a. Display 602a and force reflection interface 596a attaches to computer 604a, which runs software 606a (a video game preferably). Computer 604a sends and receives packets over network signal 610a, through network 608. Force reflection interface 596b attaches to grounded surface 514b. User 600b holds handle 598b, which is attached to the output of force reflection interface 596b. Display 602b and force reflection interface 596b attaches to computer 604b, which runs software 606b (a video game preferably). Computer 604b sends and receives packets over network signal 610b, through network 608. Computers 604a and 604b are related to each other through a network architecture such as client-server or peer-to-peer over the network 608. Computers 604a and 604b trade information over network 608, either via a peer-to-peer network or indirectly, such as through a game server in a client-server architecture. Displays 602a and 602b display similar 3D representations from game 606a and 606b. Handles 598a and 598b represent sword-like devices in games 606a and 606b (606a and 606b are instances of the same game preferably, and as such they will be referred to jointly as “the game” or game 606). When the sword-like devices represented by handles 598a and 598b contact each other in game 606, users 600a and 600b feel forces related to the collision within a few seconds (or less) of each other. FIG. 151 shows a flowchart of the process of detecting a collision between a cylindrical virtual object represented by handle 598a and a cylindrical virtual object represented by handle 598b in game 606a. For example, modeling the blades of swords as cylinders considerably simplifies determining whether they have collided.

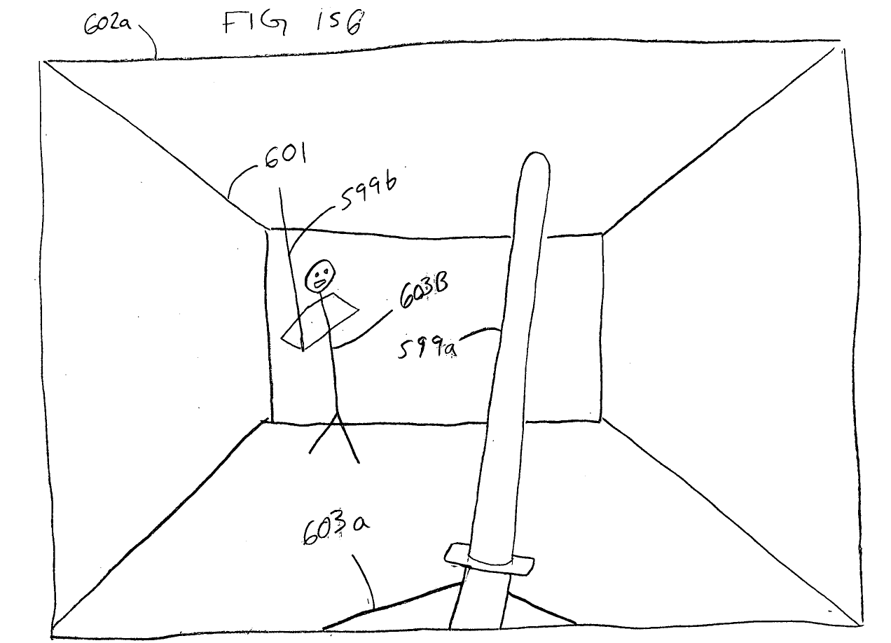

The sword-like devices in game 606 are virtual objects and only exist in the world of the game. To represent them in the real world to the users, handles 598a and 598b are constructed in such a way so as to correspond to the general size, shape, and feel of what the users appear to be holding in the virtual world of game 606, as represented to them through their displays, 602a and 602b. FIG. 156 shows 3d representation 601 in game 606, along with user 600a's sword-like device 599a held by character 603a, the virtual persona that user 600a controls. Similarly, user 600b is represented by 603b in 3d representation 601 of game 606, and wields sword-like device 599b, which is represented by handle 598b. Advantageously, users 600a and 600b can virtual sword-fight without the chance of injuring each other. Interfaces 596a and 596b are capable of exerting or damping in excess of 10 lbs of force in three dimensions while handle 598a changes both position and orientation as user 600a holds it. User 600a can move handle 598a at least 24 inches in the direction directly in front of him, swing handle 598a at least 36 inches from side to side, and swing handle 598a up or down at least 36 inches preferably.

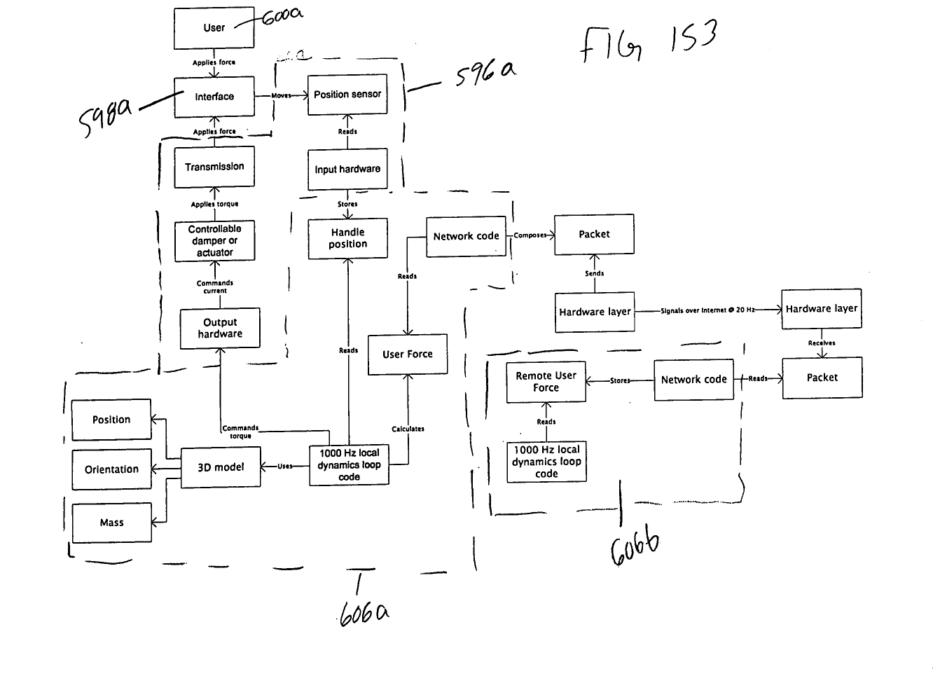

FIG. 153 describes the system shown in FIG. 148 in additional detail. Although FIG. 153 only shows from user 600a to the 1000 Hz local dynamics control loop of user 600b, the system is symmetric, such that the same set of boxes and arrows exist between user 600b and the 1000 Hz local dynamics loop code of 606b as there is between user 600a and the 1000 Hz local dynamics loop code of 606a.

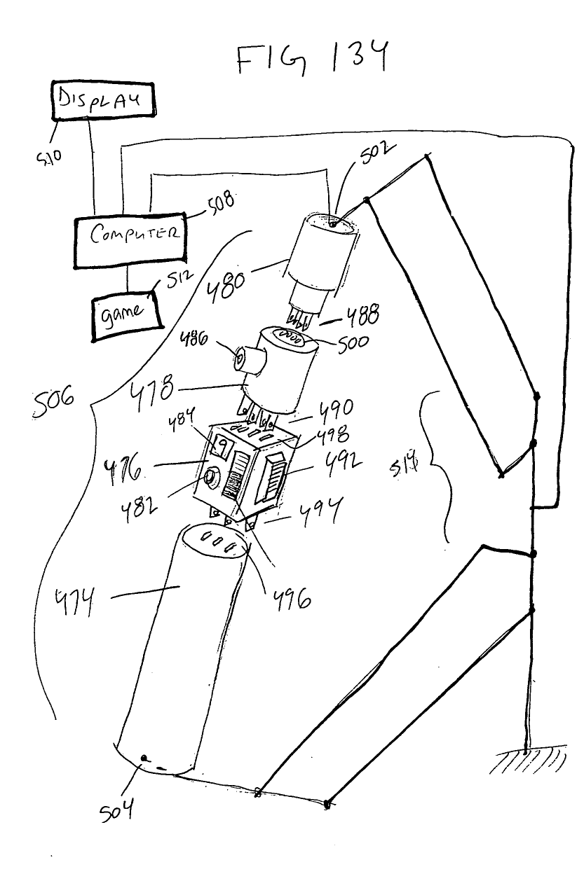

In the preferred embodiment, handle 598a is comprised of interface 506, as shown in FIG. 134, which is removably attached to force reflection interface 596a. Interface 506 is comprised of handle 474, which is attached to interchangeable section 476, interchangeable component 478, and interchangeable endpiece 480. Female electrical connector 496 connects to male electrical connector 494 when handle 474 is assembled together with interchangeable section 476. Interchangeable section 476 includes a plurality of controls including switch 492 and button 482, along with display 484. Interchangeable component 478 vibrates and heats up (it has a small motor with an eccentric weight attached to its shaft inside and a thin-film resistive heating element wrapped around its outside). Vibrations from interchangeable component 478 is transmitted to the entire interface 506 once it is mechanically joined to the interface. Heat from interchangeable component 478 is felt by the user holding the handle. Interchangeable component 478 connects electrically to interchangeable section 476 through the mating of male connector 490 to female connector 498. Endpiece 480 carries signals through the mating of male connector 488 with female connector 500 to computer 508, which is connected to display 510. Alternatively, 476, 478, and 480 can be linked by a wireless network instead of a physical connector; additionally, interface 506 could be linked to computer 508 via a wireless network. Game 606a, through force reflection actuation device 596a and interface 506, can change the properties of interface 506 to reflect that of the properties of the object it represents in game 506a. For example, when a character in the game picks up a heavier sword, interface 506 can be made to feel heavier to the user 600a. Advantageously, the modular construction of interface 506 allows the user of interface 506 to customize it, and therefore his or her game experience. Interface 506 communicates with computer 604a to relay what components are attached; information from computer 604a likewise flows to interface 596a to update, for example, display 602a. Interchangeable section 476, interchangable component 478, and interchangeable endpiece 480 are available with different properties, both physically (in the real world, such as mass, size, shape, color, paint, stickers, etc. . . .) and virtually (i.e., weapon damage, color, weapon speed, etc. . . .) within game 606a running on computer 604a and displayed on display 602a. Different versions of interchangeable section 476, interchangable component 478, and interchangeable endpiece 480 can be purchased at retail stores in sealed, non-transparent boxes that prevent the user from knowing which versions they are buying. Interchangeable section 476, interchangable component 478, and interchangeable endpiece 480 are collectable, with different levels of rarity corresponding to the familiar common, uncommon, and rare categorization seen in popular collectable card games such as MAGIC: THE GATHERING. Some features in game 606a running on computer 604a and displayed on display 602 can be “unlocked” (i.e., become usable) by using a particular interchangeable section 476, interchangable component 478, and interchangeable endpiece 480, or combination thereof. Some versions of these components may have switches, displays, etc. . . . that others do not have. Advantageously, all these features make collecting different versions of interchangeable section 476, interchangable component 478, and interchangeable endpiece 480 highly entertaining.

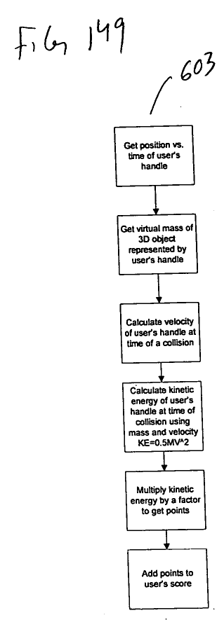

Flowchart 603 of FIG. 149 shows a process by which a score in the game is generated for a virtual object swing in game 606a based on the kinetic energy of the virtual object represented by handle 598, which is a function of the velocity with which user 600a swings handle 598a.

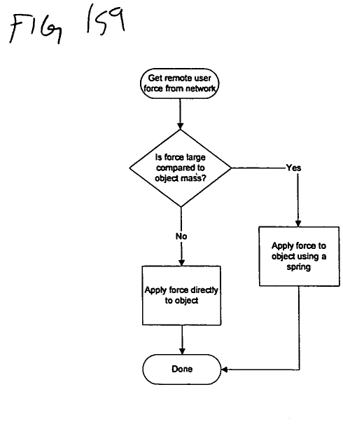

FIG. 159 shows a flowchart for a method of dealing with applying a force to an object that is relatively large compared to the mass of the object, so as to cause excessive acceleration. The problem of excessive accelerations would be noticable in a networked force reflection system such as is shown in FIG. 148, particularly if going over a network such as the Internet where high latency will be encountered.

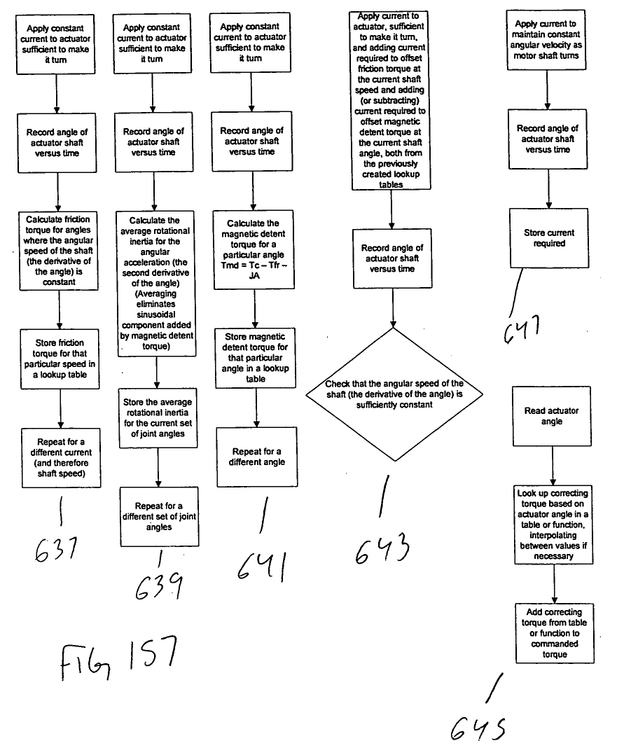

FIG. 157 describes several methods within game 606a or other application. Flowchart 637 is a method by which the friction of the actuators of force reflection interface 596a is computed. Flowchart 641 is a method by which the magnetic detent torque as a function of actuator shaft angle is determined. Flowchart 639 is a method by which the inertia of the force reflection interface 596a with respect to a driven axis is determined. Flowchart 643 is a method of checking whether the processes in flowcharts 639 and 641 were effective. Flowchart 645 is a method by which a correcting torque is applied to an actuator of force reflection interface 596a to correct for magnetic detent, friction, or other effects that affect the quality of movement handle 598a. Flowchart 647 is a method for generating the correcting torque used in Flowchart 645. Cancelling friction can quickly cause a system to go out of control, however, as the slightest force, applied, continously, should accelerate an object continuously. Therefore, a maximum velocity is used to prevent such instability.

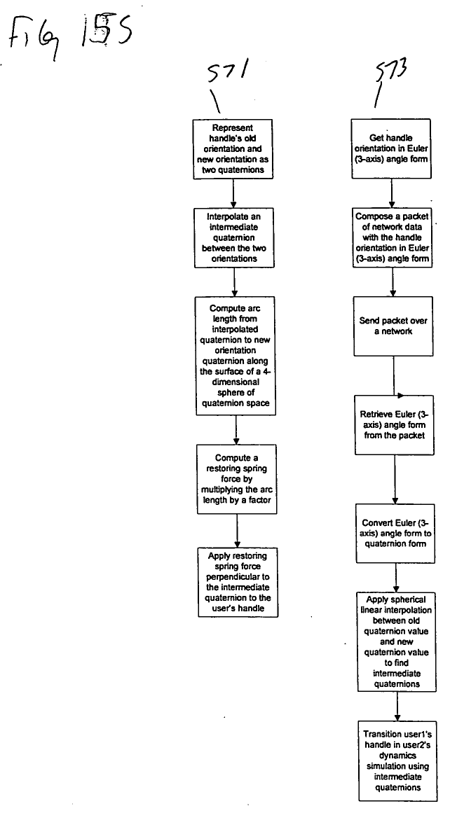

Flowchart 571 of FIG. 155 shows a method by which smooth transitions from different orientations of virtual objects within game 606a are accomplished. Flowchart 573 shows a means of efficiently communicating changes in orientation of handle 598a over network 608.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

For example, grounded surface 614a and 614b can be attached to user 600a and 600b, respectively, instead of a rigid surface. This allows the users to move around freely.

1. A networked force reflection system comprising:
a user;
a handle attached to a force reflecting interface; and
a fixed surface.
